(19) United States
(12) Patent Application Publication
(10) Pub. No.: US 2024/0136904 A1
(43) Pub. Date: Apr. 25, 2024

(54) FLUX MACHINE

(71) Applicant: ClearWater Holdings, Ltd., Carson City, NV (US)

(72) Inventors: G. Noah Newmark, Marina del Rey, CA (US); Stephen M. Collins, Westerville, OH (US); R. Morgan Harwith, Marina del Rey, CA (US)

(21) Appl. No.: 18/402,363

(22) Filed: Jan. 2, 2024

Related U.S. Application Data
(63) Continuation of application No. 15/327,608, filed on Jan. 19, 2017, now Pat. No. 11,894,739.
(60) Provisional application No. 62/028,220, filed on Jul. 23, 2014.
(60) Provisional application No. 62/028,235, filed on Jul. 23, 2014.

(51) Int. Cl. H02K 21/24; H02K 16/02; H02K 21/12; H02K 51/00

(52) U.S. Cl. CPC H02K 21/24; H02K 16/02; H02K 21/12; H02K 51/00; H02K 21/22

(57) ABSTRACT

A flux machine has plural coil assemblies and plural magnet sets arranged in mutual close proximity and circularly about a central axis. Either one of the coil assemblies and the magnet sets are supported by at least one axle which is aligned with the central axis, and either one of the coil assemblies and magnet sets executes rotary motion about the central axis when electrical current is present in the coil assemblies. Magnetic flux of the magnet sets is directed axially and radially while machine rotation is orthogonal to the direction of flux. A plurality of magnets in each magnet set are supported by one or another of a plurality of coaxially aligned axles so that the flux machine may operate as an electrical motor, as an electrical generator, or both at the same time.

### TECHNICAL FIELD

This disclosure relates to rotating electromagnetic motors and generators.

### BACKGROUND ART

Magnet transverse flux machines conduct magnetic flux perpendicular (transverse) to the current in the coil and can produce higher torque density than standard brushless machines with longitudinal flux. Such machines have high power density and can be used both as motors and generators. Torque increases with the number of poles at a constant stator current. Due to the high number of poles in a transverse flux machines, the frequency of electric current in stator windings is high while shaft speed is low. Such machines have a three dimensional magnetic circuit which has traditionally made fabrication and assembly of stator and rotor components difficult. Prior art methods of manufacturing the magnetic circuits require the formation of individual U-shaped magnetic circuits. For example, a U-shaped magnetic circuit may be comprised of a plurality of individual U-shaped laminations stacked together. Assembly of such machines then requires the correct placement, alignment and spacing of each U-shaped magnetic circuit. Another method known in the prior art is to construct two 3D stacks, each having one half of every magnetic circuit as a series of L-shaped protrusions. When joined together around the coil, the magnetic circuits are completed in the U-shape. This method requires the construction of a stack with a complex three-dimensional shape and requires precise rotational alignment of the stacks to properly form the magnetic circuit. The present flux machine described herein is simple to manufacture and assemble, is compact and has other novel and highly beneficial aspects. The prior art relevant to the present disclosure is included in the following table and incorporated herein by reference:

| | Filing | Publication | | |
|---|---|---|---|---|
| Cited Patent | date | date | Applicant | Title |
| U.S. Pat. No. 4,973,868 | Jul. 28, | Nov. 27, 1990 | J. M. Voith | Electrical machine |
| | 1989 | | Gmbh | with permanent magnet |
| | | | | excitation |
| U.S. Pat. No. 5,051,641 | Feb. 5, | Sep. 24, 1991 | J. M. Voith | Transversal flow |
| | 1988 | | Gmbh | machine in |
| | | | | accumulator |
| | | | | arrangement |
| U.S. Pat. No. 5,117,142 | Jan. 30, | May 26, 1992 | 501 Ibk Ab | Permanent magnetized |
| | 1991 | | | synchronous machine |
| | | | | designed according to |
| | | | | the transverse flux |
| | | | | principle |
| U.S. Pat. No. 5,289,072 | Oct. 15, | Feb. 22, 1994 | J. M. Voith | Electrical machine |
| | 1991 | | Gmbh | |
| U.S. Pat. No. 5,543,674 | Jun. 28, | Aug. 6, 1996 | Radio Energie | Dynamoelectric |
| | 1991 | | | machine composed of |
| | | | | sectors having |
| | | | | transverse fluxes |
| U.S. Pat. No. 5,777,418 | Jun. 17, | Jul. 7, 1998 | Voith Turbo | Transverse flux motor |
| | 1996 | | Gmbh | with magnetic floor |
| | | | | gap |
| U.S. Pat. No. 5,942,828 | Jun. 23, | Aug. 24, 1999 | Hill; Wolfgang | Transverse flux |
| | 1997 | | | machine |
| U.S. Pat. No. 5,973,436 | Jul. 30, | Oct. 26, 1999 | Rolls-Royce | Electrical machine |
| | 1997 | | Power | |
| | | | Engineering | |
| | | | Plc | |
| U.S. Pat. No. 6,043,579 | Jan. 6, | Mar. 28, 2000 | Hill; Wolfgang | Permanently excited |
| | 1998 | | | transverse flux |
| | | | | machine |
| U.S. Pat. No. 6,492,758 | Nov. 1, | Dec. 10, 2002 | Fisher & | Polyphase transverse |
| | 2000 | | Paykel Limited | flux motor |
| U.S. Pat. No. 6,700,267 | Jan. 25, | Mar. 2, 2004 | Deere & | Transverse flux drive |
| | 2002 | | Company | |
| U.S. Pat. No. 6,729,140 | Jan. 30, | May 4, 2004 | Rolls-Royce | Electrical machine |
| | 2002 | | Plc | |
| U.S. Pat. No. 6,741,010 | Jan. 8, | May 25, 2004 | Rolls Royce | Rotor disc assembly |
| | 2001 | | Plc | having rotor rim with |
| | | | | alternate magnets and |
| | | | | laminated pole pieces |
| U.S. Pat. No. 6,847,135 | Dec. 11, | Jan. 25, 2005 | Robert Bosch | Unipolar transverse |
| | 2002 | | Gmbh | flux machine |
| U.S. Pat. No. 6,888,272 | Aug. 1, | May 3, 2005 | Robert Bosch | Unipolar transverse |
| | 2002 | | Gmbh | magnetic flux machine |
| U.S. Pat. No. 6,952,068 * | Dec. 18, | Oct. 4, 2005 | Otis Elevator | Fabricated components |
| | 2000 | | Company | of transverse flux |
| | | | | electric motors |
| U.S. Pat. No. 7,030,529 | Jan. 29, | Apr. 18, 2006 | Robert Bosch | Electrical machines, |
| | 2003 | | Gmbh | especially engines |
| | | | | excited by permanent |
| | | | | magnets |
| U.S. Pat. No. 7,124,495 | May 31, | Oct. 24, 2006 | Otis Elevator | Method for making an |
| | 2005 | | Company | electric motor |
| U.S. Pat. No. 7,164,220 * | May 12, | Jan. 16, 2007 | Rolls-Royce | Stator pole structure |
| | 2005 | | Plc | for an electrical |
| | | | | machine |
| U.S. Pat. No. 7,312,549 | May 8, | Dec. 25, 2007 | Aalborg | Transverse flux |
| | 2002 | | Universitet | machine with stator |
| | | | | made of e-shaped |
| | | | | laminates |
| U.S. Pat. No. 7,466,058 | Jun. 28, | Dec. 16, 2008 | Eocycle | Transverse flux |
| | 2006 | | Technologies, | electrical machine with |
| | | | Inc. | segmented core stator |
| U.S. Pat. No. 7,492,074 | Mar. 30, | Feb. 17, 2009 | Norman | High-efficiency wheel- |
| | 2007 | | Rittenhouse | motor utilizing molded |
| | | | | magnetic, flux channels |
| | | | | with transverse-flux |
| | | | | stator |
| U.S. Pat. No. 7,579,742 | Jan. 17, | Aug. 25, 2009 | Norman | High-efficiency |
| | 2008 | | Rittenhouse | parallel-pole molded- |
| | | | | magnetic flux channels |
| | | | | transverse wound |
| | | | | motor-dynamo |
| US20010008356 | Jan. 8, | Jul. 19, 2001 | Wilkin | Rotor disc |
| | 2001 | | Geoffrey A | |
| US20040155548 | May 8, | Aug. 12, 2004 | Rasmussen | Transverse flux |
| | 2002 | | Peter Omand | machine with stator |
| | | | | made of c-shaped |
| | | | | laminates |
| US20040251759 | Jun. 9, | Dec. 16, 2004 | Hirzel Andrew D. | Radial airgap, |
| | 2004 | | | transverse flux motor |
| US20060192453 | May 27, | Aug. 31, 2006 | Gieras Jacek F | Modular transverse |
| | 2003 | | | flux motor with |
| | | | | integrated brake |
| US20070216249 | Apr. 28, | Sep. 20, 2007 | Mtu Aero | Transverse flux |
| | 2006 | | Engines Gmbh | machine and turbine- |
| | | | | type machine having |
| | | | | such a transverse flux |
| | | | | machine |
| US20070267929 | May 11, | Nov. 22, 2007 | Minebea Co., | Stator arrangement and |
| | 2007 | | Ltd. | rotor arrangement for a |
| | | | | transverse flux |
| | | | | machine |
| US20080136272 | Dec. 5, | Jun. 12, 2008 | Toshio | Rotating electrical |
| | 2007 | | Ishikawa | machine |
| US20080211326 | Dec. 28, | Sep. 4, 2008 | Korea Electro | Inner rotor type |
| | 2007 | | Technology | permanent magnet |
| | | | Research | excited transverse flux |
| | | | Institute | motor |
| US20080246362 | May 21, | Oct. 9, 2008 | Hirzel Andrew D | Radial airgap, |
| | 2008 | | | transverse flux |
| | | | | machine |
| US20090026869 | Jul. 16, | Jan. 29, 2009 | Christian | Transverse flux |
| | 2008 | | Kaehler | reluctance machine and |
| | | | | method for |
| | | | | manufacturing same |
| US20090108712 | Jul. 25, | Apr. 30, 2009 | Holtzapple | Short-flux path motors/ |
| | 2008 | | Mark T | generators |
| DE10037787A1 | Aug. 3, | Mar. 14, 2002 | Landert | Permanent magnet |
| | 2000 | | Motoren Ag | excited synchronous |
| | | | | machine e.g. general |
| | | | | purpose drive motors, |
| | | | | has external rotor |
| | | | | design with external |
| | | | | rotor joined |
| | | | | rotationally-rigidly to |
| | | | | rotatable shaft, around |
| | | | | common axis |
| WO2006117210A1 | May 4, | Nov. 9, 2006 | Bosch Rexroth | Phase module for a |
| | 2006 | | Ag | transverse flux motor |
| WO2007000054A1 | Jun. 26, | Jan. 4, 2007 | Maxime R | Transverse flux |
| | 2006 | | Dubois | electrical machine with |
| | | | | segmented core stator |
| WO2009070333A1 | Nov. 28, | Jun. 4, 2009 | Norman P | Wind turbine generator |
| | 2008 | | Rittenhouse | |

### DISCLOSURE OF INVENTION

The drawings illustrate a novel electromagnetic rotating flux machine 10 having manufacturing and operational advantages with respect to the prior art. For example, flux density is relatively high, and the pole number may be increased without reducing magnetomotive force per pole, enabling higher power densities. Further advantages include a large number of poles with relatively short current pathways enabling efficiency gains due to a high torque/weight ratio, a high power/weight ratio and relatively low copper losses.

An arrangement of coils and magnets has been developed with magnetic flux directed from four or more directions coupled into coil assemblies. For instance, there may be two magnets that are oriented with poles facing for directing magnetic flux in a radial direction from opposite sides of the coils, and two additional magnets that are oriented with poles facing axially, to direct flux axially from opposite sides of the coils. Additionally, the coils may be oriented so that the windings and current within those windings flows in a plane that is perpendicular to a vector pointing in an established circumferential direction of motion of a rotor of the flux machine.

Thus, the magnets may be adjacent to different sides of the coils but and all magnetic flux circuits combine additively.

With the magnets (electromagnets or permanent magnets, or a combination of the two) mounted on independent rotors and axels as described herein, they may be operated independently at different frequencies and/or as a motor and generator independently and simultaneously. These innovations are possible given the orientation of the coils that sit in a plane that is perpendicular to the rotational axis of the machine. Rotation causes a relative motion between magnets and coils with the magnets and coils close coupled with a minimum air gap therebetween.

### BRIEF DESCRIPTION OF DRAWINGS

Embodiments of the described machine are illustrated by way of example in the figures of the accompanying drawing sheets, in which like references indicate similar elements and in which:

FIG. 1 is a perspective view of a flux machine according to the following detailed description;

FIG. 2 is a perspective expanded view thereof;

FIG. 3 is a perspective view of an outer rotor-magnet assembly of an embodiment thereof;

FIG. 4 is an elevation view of a stator plate of an embodiment thereof;

FIG. 5 is a perspective view of an exemplary coil assembly and magnets hereof;

FIGS. 6-8 are exemplary conceptual diagrams of arrangements of said coil assemblies, magnets, supporting frames with axles; and

FIG. 9 is an exemplary mechanical schematic diagram of a further arrangement as in FIGS. 6-8.

### BEST MODES FOR CARRYING OUT THE INVENTION

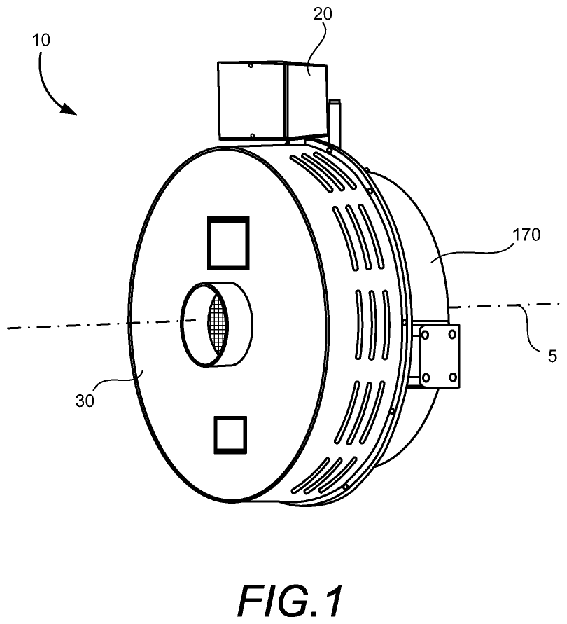

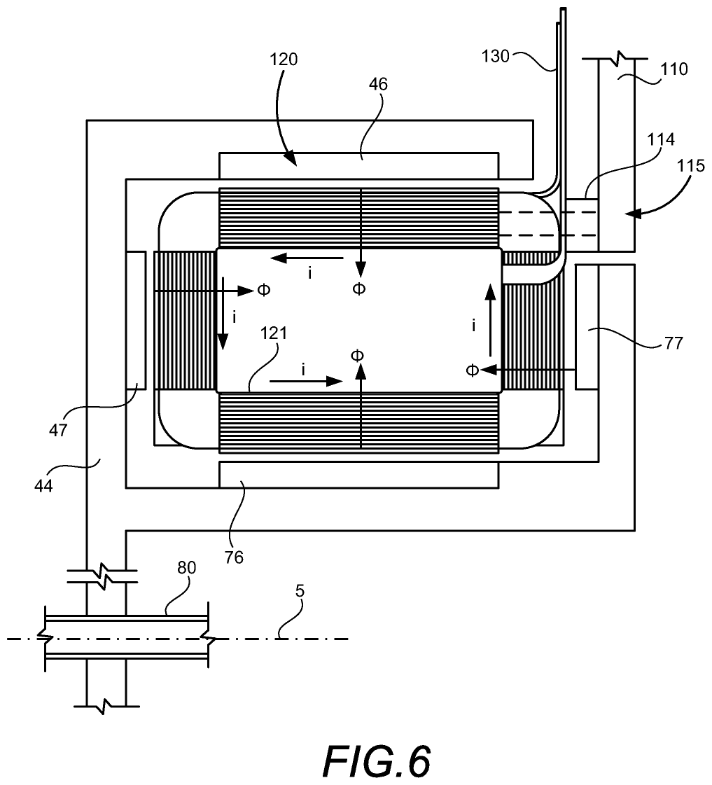

FIG. 1 shows that machine 10 may be generally circular in shape and relatively short axially between shroud 30 and flywheel housing 170 providing space and weight savings. Electrical connections to machine 10 may be made via a standard connection box 20 and mechanical engagement may be made via one or more coaxial shafts aligned with central axis 5 as shown in the FIGS. 6-9.

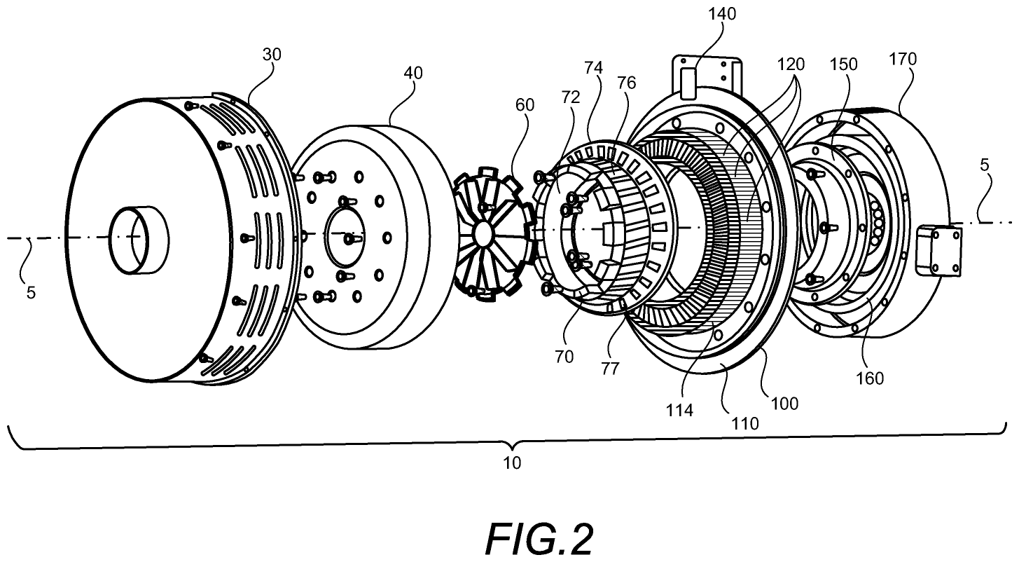

FIG. 2 illustrates several components and sub-assemblies of machine 10 according to embodiments, showing their relative axial positions. Moving from left to right in FIG. 2, shown are: shroud 30, outer rotor-magnet assembly 40, fan 60, inner rotor-magnet assembly 70, stator assembly 100 with coil assemblies 120, rotor hub 150, flywheel 160, and flywheel housing 170. These components are aligned about common axis 5 which is also the center of rotation of machine 10. In embodiments, outer rotor-magnet assembly 40, fan 60, inner rotor-magnet assembly 70, rotor hub 150, and flywheel 160 may be mutually joined mechanically and therefore may rotate together. In other embodiments some of these elements and other elements may be adapted for independent rotation about coaxial shafts as will be discussed and shown. In embodiments shroud 30, stator assembly 100 and flywheel housing 170 may not rotate, may be mutually mechanically joined, and may be fixed in place as a stator. In other embodiments stator assembly 100 may be mounted for rotation about a central axle with each of the winding phases connected via a standard rotary electrical interface, such as those commonly found in slip ring motors. Assembly 100 would therefore function as the rotor of machine 10 while outer rotor-magnet assembly 40 and inner rotor-magnet assembly 70 may function as the stator of machine 10. Those of skill would understand how to make this simple adaptation.

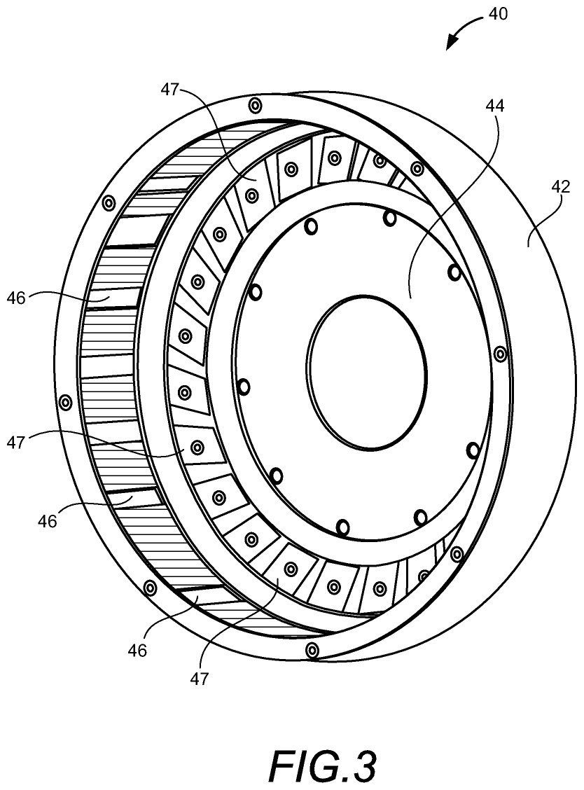

As exemplified in FIG. 3 the sets of axially aligned magnets 46 and radially aligned magnets 47 may be held in circular fixed positions as part of an outer rotor assembly 40 attached to a single axle. Alternately, magnets 46, 47 may be secured to one or more axially aligned axles by distinct mechanical frames as shown in FIGS. 6-9.

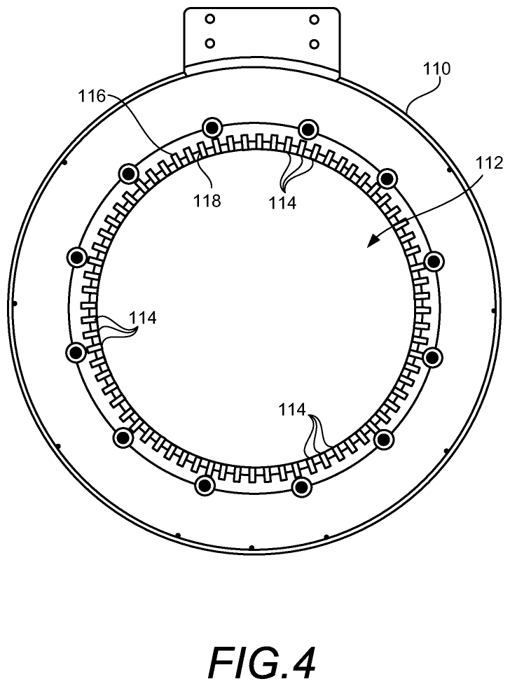

FIG. 4 illustrates circular plate 110 of stator assembly 100 which may have central circular opening 112 large enough in diameter to accept outer flange 74 of assembly 70 (FIG. 2). As shown in FIGS. 6-8, mounting standoffs 114 or similar hardware may be used to secure coil assemblies 120 to plate 110. In FIGS. 6-8, fasteners, shown as hidden lines 115 may be used to secure coil assembly 120 to standoffs 114.

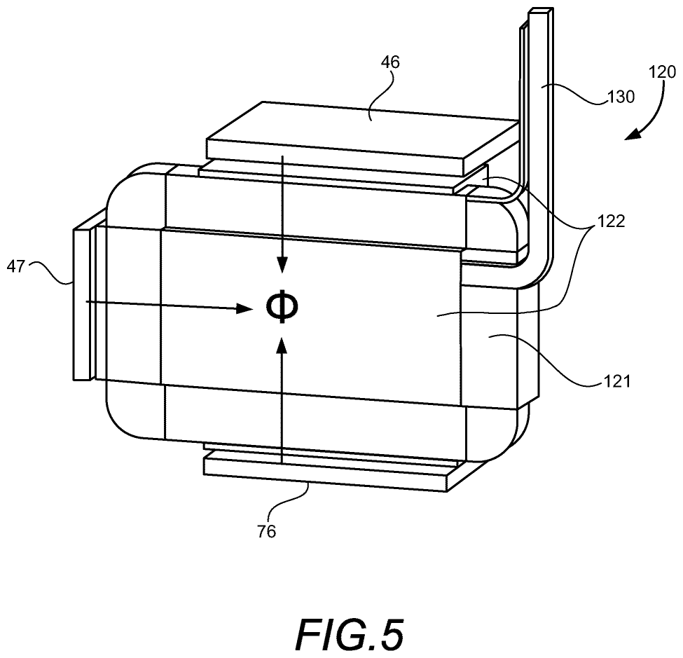

FIG. 5 shows that coil assembly 120 may be rectangular, near rectangular, curvilinear, ovular, or other shapes. Electrical coil 121 may be made of wound flat, round or other shaped electrical conductors such as electrical copper or aluminum strip, and may be placed within core stack 122. Core stack 122 may be of soft iron, laminated silicon steel, insulated iron sheets, carbonyl iron, iron powder, ferrite, vitreous metal or other materials and structures. In embodiments, coil assembly 120 may be ovular, rectangular, circular or other suitable shapes. A full complement of mounted coil assemblies 120 are shown in FIG. 2 secured to standoffs 114. In FIG. 5, magnets 46, 47, and 76 are shown as close coupled to core stack 122. The direction of lines of magnetic flux Φ (the primary or largest component of the magnet flux for each magnet) are shown by arrows. It is noted that in FIG. 5 no magnet is positioned along the right edge of coil assembly 120. It should be realized that magnets 46, 47, 76, (and 77 as shown in FIG. 6) are positioned immediately adjacent to the sides of coil assembly 120 for maximizing magnetic flux linkage and assuring low reluctance. Any or all of magnets 46, 47, 76 or 77 may be permanent magnets or electromagnets, with all magnets directly attached to axles utilizing slip ring or other rotary electrical interfaces as are known in the electromechanical arts. Although the side edges of coil assemblies 120 are shown linear in FIGS. 5-9 these edges may be non-linear and the adjacent surfaces of magnets 46, 47, 76, and 77 may conform so that air gaps between magnets and coil assemblies are minimized. Therefore, coil assemblies 120 may be other than rectangular as those of skill in the electrical arts will appreciate. As shown in referenced applications U.S. 62/028,220, and U.S. 62/028,235 more than three magnets may be arranged so as to be close coupled with coil assemblies 120 during machine rotation.

FIG. 6 shows that a structural frame 44 may extend around four sides of coil assemblies 120 and may secure magnets 46, 47, 76 and 77 in close coupled positions. Structural frame 44 may extend as a continuous circular assembly, or may be arranged as a series of radial spokes arranged over 360 degrees and may comprise one (or more or less) said spoke 44 for each coil assembly 120. Frame 44 may be fixed to axle 80 which is aligned with central axis 5. As axle 80 is rotated, by an external motor for instance, all of the sets of magnets 46, 47, 76, and 77 pass coil assemblies 120 producing a Faraday current. FIG. 6 illustrates a single axle machine 10.

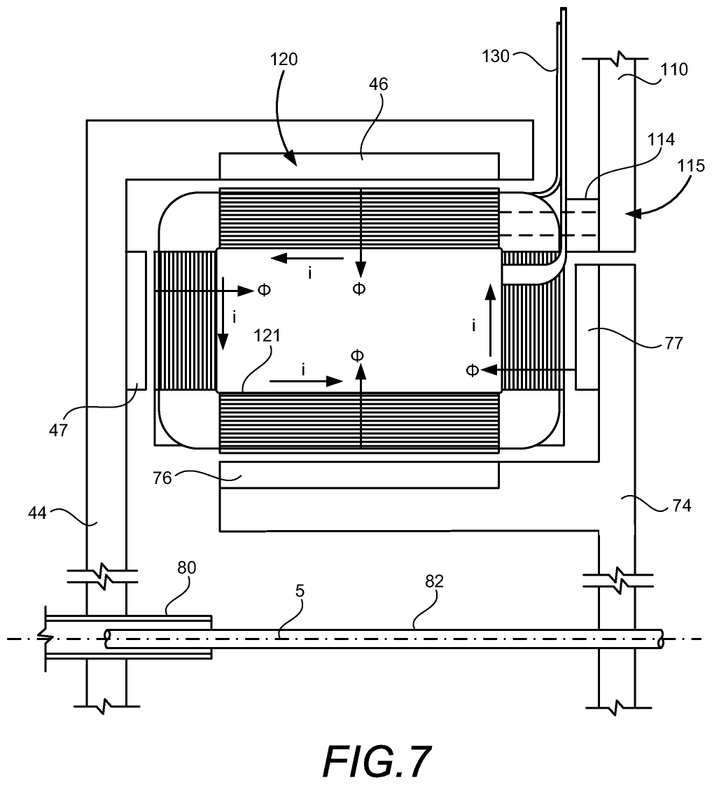

FIG. 7 shows that structural frame 44 may extend around two sides of any one of coil assemblies 120 and may secure magnets 46 and 47 in preferred positions, close coupled to two sides, in turn, of each one of coil assemblies 120 during rotation. As with the arrangement shown in FIG. 6, frames 44 may be secured to axle 80 as shown. A further structural frame 74 may extend around the remaining two sides of coil assemblies 120 and may secure magnets 76 and 77 in place close coupled to coil assemblies 120 and may be secured to axle 82 as shown. Axles 80 and 82 may be coaxially aligned and may be mutually free in rotation. In both motor and generator operation, depending on magnet polarity the axles may rotate in the same or opposite senses. In motor operation the axles will both rotate at the same rpm, while in generator mode the axle may rotate at different rpms as long as electrical phase synchrony is maintained. It is possible for one driven axle to function in generator mode adding a supplementary current to inlet current at input lines 130, while the second axle functions in motor mode driven by the total of input and supplementary currents. FIG. 7 illustrates a dual axle machine 10.

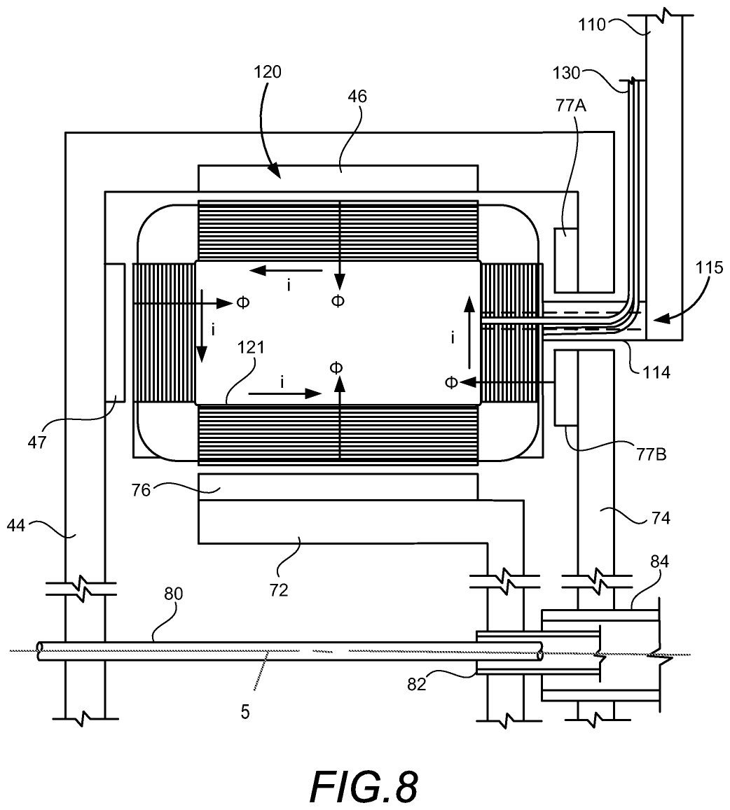

FIG. 8 shows that three structural frames 44, 72, and 74 may secure magnets 46, 47, 72, 77A and 77B. In this arrangement magnet 77 is replaced by two magnets 77A and 77B as shown. Frames 44, 72, and 74 may be secured to coaxial axles 80, 82 and 84 as shown. In both motor and generator operation, depending on magnet polarity the axles may rotate in the same or sense or not. In motor operation the axles will all rotate at the same rpm, while in generator mode the axle may rotate at different rpms as long as electrical phase synchrony is maintained. It is possible for a driven axle to function in generator mode adding a supplementary current to inlet current at input lines 130, while another axle functions in motor mode driven by the total of input and supplementary currents. Of course all axles may be driven by different rotational drivers and may deliver rotational forces to different loads. It should be clear that each magnet 46, 47, and 76 may be replaced by multiple magnets in the manner of magnet 77 being replaced by magnets 77A and 77B. FIG. 8 illustrates a triple axle machine 10.

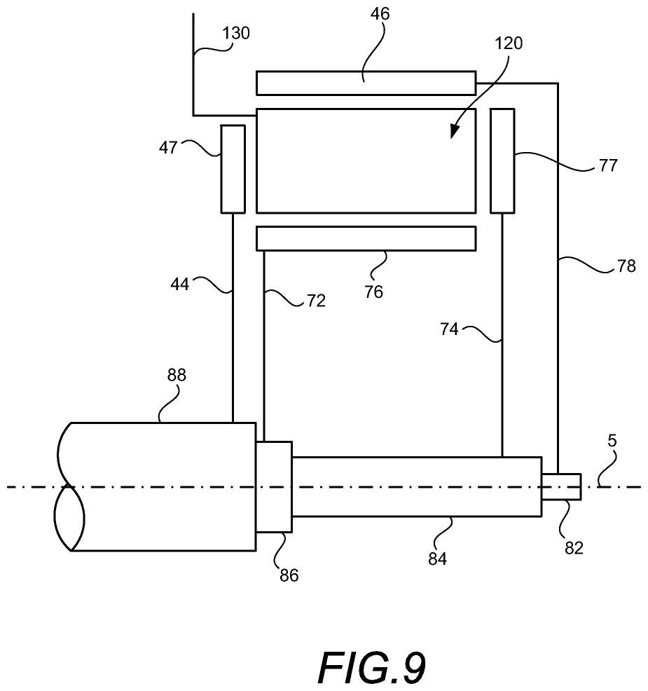

FIG. 9 illustrates a four axle machine, axles 82, 84, 86, and 88, wherein four magnets 46, 47, 76, and 77 may be mounted by frames 44, 72, 74, and 78 to one of the four axles. In like manner if each one of magnets 46, 47, 76, and 77 were to be replaced by two magnets as shown in FIG. 8, all eight magnets can be supported by eight coaxial axles and machine 10 can be used to drive eight separate rotational loads. FIG. 9 illustrates a quad-axle machine 10.

For coaxial integration and operation all said axles except the inner most axle, can be tubular as shown in FIGS. 6-9 and may include toroidal bearings to maintain their mutual coaxial positions and spacing while preserving rotational independents as is known in the mechanical arts. The outermost of the coaxial axles, for instance axle 88 in FIG. 9, may be supported by exterior bearing sets so as to secure all of the axles in their position centered on axis 5 as is also well known.

As shown in FIGS. 6 and 7 the direction of flux, or the primary component (the largest component for each magnet) may be axial or radial. The direction of rotation of machine 10 may be orthogonal to the orientation of flux circuits. Therefore, machine 10 is considered to be a transverse flux machine. It is noted that a normal vector to coil assemblies 120 mounted on the stator of machine 10 defines rotor rotation direction and the magnitude of rpm.

In the foregoing description, embodiments are described as a plurality of individual parts, and this is solely for the sake of illustration. Accordingly, it is contemplated that some additional parts may be added, some parts may be changed or omitted, and the order of the parts may be re-arranged, without leaving the sense and understanding of the apparatus as claimed.

### INDUSTRIAL APPLICABILITY

The several embodiments described make such machines desirable in a variety of applications including: propulsion motors for land and sea vehicles, electric and hybrid electric vehicles, underwater vehicles, torpedoes, propulsion motors for electric helicopters and aircraft, elevator propulsion motors, tidal wave generators, wind generators, integrated starter/generators, diesel and natural gas gen-sets, and high frequency low speed machines.

1-34. (canceled)

35. A flux machine comprising:
a stator;
a plurality of rotors configured to rotate in a rotary direction about a central axis of the plurality of rotors, the plurality of rotors including at least a first rotor and a second rotor configured to rotate independently from one another about the central axis in the rotary direction;
a plurality of magnet sets coupled to the plurality of rotors, each magnet in each of the plurality of magnets sets being configured to direct magnetic flux in an axial direction or a radial direction; and
a plurality of coil assemblies coupled to the stator, each of the plurality of coil assemblies including a respective coil and a respective core stack that has a first portion and a second portion, the respective coil of each of the plurality of coil assemblies being wound at least partially about a first portion of the respective core stack, the second portion of the respective core stack being positioned between at least one side of the respective coil and at least one magnet from one of the plurality of magnet sets, each of the plurality of coil assemblies being oriented such that current within the plurality of coil assemblies generally flows in a plane perpendicular to the rotary direction;
wherein each of the plurality of magnets sets includes a first magnet coupled to the first rotor and a second magnet coupled to the second rotor, the first magnet of each of the plurality of magnets sets being configured to direct magnetic flux in an axial direction toward or away from a first side of a corresponding one of the plurality of coil assemblies, the second magnet of each of the plurality of magnet sets being configured to direct magnetic flux in a radial direction toward or away from a second side of the corresponding one of the plurality of coil assemblies; and
wherein the first rotor includes a first axle configured to rotate about the central axis and the second rotor includes a second axle configured to rotate about the central axis such that the first magnet of each of the plurality of magnet sets is configured to move relative to the second magnet of each of the plurality of magnet sets when electrical current is present in at least one of the plurality of coil assemblies.

36. The flux machine of claim 35, wherein the first magnet and the second magnet of each of the plurality of magnet sets are permanent magnets, electromagnets, or a combination of permanent magnets and electromagnets.

37. The flux machine of claim 35, wherein both the first magnet and the second magnet direct magnetic flux orthogonal to the rotary direction.

38. The flux machine of claim 35, wherein magnetic flux of each of the plurality of magnet sets is configured to be directed perpendicularly to a plane of the current flowing in a corresponding coil assembly.

39. The flux machine of claim 35, wherein the first rotor includes a third magnet and a fourth magnet.

40. The flux machine of claim 35, further comprising a third rotor, and wherein each of the plurality of magnet sets further includes a third magnet and a fourth magnet, the third magnet being coupled to the first rotor and configured to direct magnetic flux toward the corresponding one of the plurality of coil assemblies in an axial direction opposing the magnet flux of the first magnet, the fourth magnet being coupled to the third rotor, such that each of the plurality of coil assemblies on the stator is surrounded by the first magnet, the second magnet, the third magnet, and the fourth magnet of one of the plurality of magnet sets.

41. The flux machine of claim 40, wherein the third rotor includes a third axle, and wherein each of the first axle, the second axle, and the third axle are configured to rotate independently of each of the other axles.

42. The flux machine of claim 41, wherein at least one of the first rotor, the second rotor, or the third rotor is configured to function as a generator simultaneously as at least one of the other rotors functions as a motor.

43. A flux machine comprising:
a stator;
one or more rotors, each rotor of the one or more rotors including an axle and a plurality of spokes extending from the axle in a radial direction;
a plurality of coil assemblies coupled to the stator; and
a plurality of magnet sets coupled to the plurality of spokes of the one or more rotors, each of the plurality of magnet sets including at least a first magnet configured to direct magnetic flux toward the plurality of coil assemblies in a first direction, and a second magnet configured to direct magnetic flux toward the plurality of coil assemblies in a second direction,
wherein the one or more rotors includes a first rotor, and wherein each of the plurality of spokes of the first rotor is coupled to the first magnet of one of the plurality of magnet sets.

44. The flux machine of claim 43, wherein the plurality of spokes of each of the one or more rotors spans 360 degrees of a circumference of the axle.

45. The flux machine of claim 43, wherein each of the plurality of spokes of the first rotor is further coupled to (i) the second magnet of the first one of the plurality of magnet sets, (ii) the first magnet of a second one of the plurality of magnet sets, or (iii) both (i) and (ii).

46. The flux machine of claim 43, wherein the first magnet of each of the plurality of magnet sets is coupled to at least two of the plurality of spokes.

47. The flux machine of claim 43, wherein each of the plurality of coil assemblies is positioned adjacent to the at least two spokes of the plurality of spokes.

48. The flux machine of claim 43, wherein the one or more rotors further includes a second rotor, the first rotor including a first plurality of spokes extending from a first axle in the radial direction, the second rotor including a second plurality of spokes extending from a second axle in the radial direction, wherein the first magnet of each of the plurality of magnet sets is coupled to a respective one of the first plurality of spokes of the first rotor, and wherein the second magnet of each of the plurality of magnet sets is coupled to a respective one of the second plurality of spokes of the second rotor.

49. The flux machine of claim 48, wherein the first rotor and the second rotor are configured to rotate independently from each other.

50. The flux machine of claim 43, wherein each of the plurality of magnet sets includes a third magnet configured to direct magnetic flux toward the plurality of coil assemblies in a third direction.

51. The flux machine of claim 50, wherein the first magnet, the second magnet, and the third magnet of each of the plurality of magnet sets is coupled to a distinct one of the plurality of spokes.

52. The flux machine of claim 50, wherein:
the one or more rotors further includes a second rotor, the first rotor having a first plurality of spokes and the second rotor having a second plurality of spokes;
the first magnet and the second magnet of each of the plurality of magnet sets are coupled to a respective one of the first plurality of spokes, and wherein the third magnet of each of the plurality of magnet sets is coupled to a respective one of the second plurality of spokes; and
each of the plurality of magnet sets includes a fourth magnet configured to direct magnetic flux toward the plurality of coil assemblies in a fourth direction, the fourth magnet of each of the plurality of magnet sets being coupled to the respective one of the second plurality of spokes.

53. The flux machine of claim 43, wherein each of the plurality of spokes of the first rotor is further coupled to the second magnet of the one of the plurality of magnet sets, and wherein each of the plurality of spokes of a second rotor of the one or more rotors is coupled to a third magnet of the one of the plurality of magnet sets, the third magnet configured to directed magnetic flux toward the plurality of coil assemblies in a third direction.

54. A method comprising:
providing the flux machine, the flux machine including:
a stator;
a plurality of rotors, the plurality of rotors including a first rotor and a second rotor configured to rotate independently about a central axis of the plurality of rotors in a rotary direction;
a plurality of coil assemblies coupled to the stator and;
a plurality of magnet sets coupled to the plurality of rotors, each magnet in each of the plurality of magnet sets being configured to direct magnetic flux in an axial direction or a radial direction, each of the plurality of magnet sets including a first magnet coupled to the first rotor and a second magnet coupled to the second rotor, the first rotor including a first axle configured to rotate about the central axis, the second rotor including a second axle configured to rotate about the central axis, the first magnet of each of the plurality of magnet sets being configured to direct magnet flux in the axial direction toward or away from a respective one of the plurality of coil assemblies, the second magnet of each of the plurality of magnet sets being configured to direct magnetic flux in the radial direction toward or away from the respective one or the plurality of coil assemblies;
electrically coupling the plurality of coil assemblies to an inlet current source to cause an inlet electrical current to flow through the plurality of coil assemblies; and
driving the first rotor externally to induce a supplementary electrical current in the plurality of coil assemblies while the second rotor is simultaneously driven by at least the inlet electrical current flowing through the plurality of coil assemblies such that the first rotor acts as a generator simultaneously as the second rotor acts as a motor.
